(19) United States
(12) Patent Application Publication
(10) Pub. No.: US 2012/0066060 A1
(43) Pub. Date: Mar. 15, 2012

(54) Systems and Methods for Commingled Mail

(76) Inventor: Kevin Wilen, Boca Raton, FL (US)

(21) Appl. No.: 13/230,601

(22) Filed: Sep. 12, 2011

Related U.S. Application Data
(60) Provisional application No. 61/382,230, filed on Sep. 13, 2010.

(51) Int. Cl. G06F 19/00; G06Q 30/00

(52) U.S. Cl. 705/14.49; 705/14.4; 700/117

(57) ABSTRACT

Systems and methods are described for creating commingled mail that can be delivered to multiple clients in mail-sorted order. The system can include a control printing device, a detection device, an inserting machine, an envelope printing device, and software installed on one or more computing devices for controlling the foregoing machines. The control printing device prints data onto a plurality of sheets of material including a unique identifier. The detection device detects each unique identifier and selects an envelope from one or more envelope feeders into which the printed sheets of material are inserted by the inserting machine. The envelope printing device prints data onto a plurality of envelopes into which the plurality of printed sheets of material are inserted.

### CROSS-REFERENCE TO RELATED APPLICATION

This application claims the priority from U.S. provisional patent application Ser. No. 61/382,230 filed Sep. 13, 2010. The foregoing application is incorporated in its entirety herein by reference.

### FIELD OF THE INVENTION

The invention relates to mail delivery. More particularly, the invention relates to systems and methods for creating commingled mail that can be delivered to multiple clients or multiple mail pieces that can be delivered to the same client.

### BACKGROUND

Commingled direct mail is defined as two or more pieces of mail within the same postal class (e.g., First Class, Standard, or Periodical) under United States Postal Service (USPS) regulations that are mailed together through the postal system. Commingled direct mail can include subscriber and nonsubscriber copies of a periodical or machinable and irregular parcels mailed in a single mailing, envelope, or package. Each piece being mailed can be of a different postal class so that the amount of postage for mailing each piece, if each piece was being mailed separately, would be different. If the mailer desires that both pieces to receive the same level of service, postage is charged on both pieces at the rate of the higher of the two classes. A commingled mailing can also be charged at each class rate as if the mail pieces were mailed separately and receive the service level of the lower class piece in the mailing. Invoices must be mailed at First Class rates regardless of the class of the partner mailing piece and the level of service desired by the mailer.

Because postage typically is one of the highest expenses of any direct mail campaign, direct mail providers have sought ways to reduce overall marketing costs and postage costs in particular. Mail commingling technology provides a favored approach to postage optimization and is gaining in popularity, especially in light of recent postal rate increases.

Commingling blends multiple mailings and/or multiple versions within the same ZIP code, ultimately increasing postal qualifications, saturation, and improving discount tier qualifications, which reduces postage costs. When combined with discounts gained through drop shipping directly to National Distribution Centers (NDCs), Sectional Center Facility (SCFs), and Division Distribution Unit (DDUs) (which are USPS mail sorting facilities), direct marketers can achieve even greater cost savings while also benefiting from faster delivery to target audiences.

First used by postal services to expedite and automate mail processing, mail sorting systems are now also used by corporations and other mailers to pre-sort mail prior to delivery in order to earn discounts on postage. These discounts apply to all classes of mail.

With the USPS introduction of postal work sharing, ZIP+4 and the POSTNET barcode in 1980, companies were given an incentive to pre-sort their mail prior to depositing it at the Post Office for delivery to the intended recipients. Today, pre-sort and automation discounts can save companies up to 50% or more on postage and many companies use mail sorters to sort both incoming and outgoing mail.

Technological advancements in variable text and imaging has started a new trend among direct marketers, who can now use sorting capabilities to transition away from mass, or “blanket,” mailings into highly targeted mailings. However, the ability to deliver more targeted mailings has also changed the percentage of mail that qualifies for five-digit postage discounts. In effect, smarter, more targeted mail carries a trade-off effect: a smaller batch that qualifies for generous, earned work-sharing discounts. The USPS requires a minimum of 150 pieces per zip code to be eligible for five-digit postal rates.

Recent innovations allow for mixed mail sorting, providing for postal discounts on letters, small parcels, flat mailers, irregularly shaped pieces, padded envelopes and even polywrap sheets. In 2007, the USPS introduced shape-based pricing which offered more significant postal discounts for mailers who sorted flat-sized mail pieces. In response to this postal change, new low-cost systems were designed specifically to support flat mail sorting for mailers who process between 500 and 10,000 First Class flats per day.

Today, most postal commingling is performed by specialty companies. Due to the nature of direct mail, these companies generally operate on a regional basis. The reasons for regional operation are that postal pre-sorting capital equipment expenses are quite high, space needed to run these types of machines and operations are significant, and several small (between 500 & 100,000 mail pieces per day) customers are required to produce a steady enough stream of mail to take advantage of both pre-sort discounts and the machine speeds. Available equipment operates at speeds of 50,000-60,000 pre-sort mail pieces per hour.

Within the USPS, the pre-sort discounts are based on the final level or degree of pre-sorting. For example, pre-sorting mail to the carrier route level provides USPS customers with a greater discount than that same mail sorted only to a zip code.

An additional aspect of pre-sorting is concentration levels. The larger the number of pieces of mail being delivered to the Post Office in sorted order, the larger the discounts yielded become. Sorting mail by zip code results in more mail being sent to the same geographic area and the availability of larger discounts. Another reason that postal pre-sorting companies are regional is that local companies tend to have mail going to the same geographic locations. As a result, few small businesses are able to take advantage of discounts on a national basis.

An envelope is a common packaging item, usually made of flat material such as paper or cardboard. Envelopes are designed to contain an object, such as a letter or card. Traditional envelopes are made primarily from sheets of paper cut to one of three shapes: a rhombus, a short-arm cross, or a kite. These shapes allow for the creation of the envelope structure by folding the sheet sides around a central rectangular area. In this manner, a rectangle-shaped enclosure is formed with an arrangement of four flaps on the reverse side.

As envelopes are made of paper, they are intrinsically amenable to embellishment with additional graphics and text over and above the necessary postal markings. This feature has long been used by the direct mail industry, which has also more recently begun using mail art as well. Custom printed envelopes have also become an increasingly popular marketing method for small businesses. Most of the over 400 billion envelopes of all sizes made worldwide are machine-made.

There are dozens of sizes of envelopes available. Not all are used for posting mail; for example, some are used for such purposes as pay packets or for enclosing a gift card or a key inside for delivery to a recipient. U.S. and Canadian postal regulations differ from those of the rest of the world. Although envelopes are still deliverable worldwide by the regulations of the Universal Postal Union, the sorting machines will not accept the international sizes. In North America, the United States and Canada have created their own common standards for envelope sizes.

The most common envelope in use today is the #10 envelope. The size of the #10 envelope is 4.125 inches by 9.5 inches and is usually constructed from 24 lb. bond paper or an equivalent. No standard exists for the placement of a window on the envelope, although most billing systems and common word processing systems generally place the window on the front in the lower left hand corner. Currently, 60% of all envelopes manufactured in the United States are #10 or #10 windowed envelopes.

At the end of the 20th century, the digital printing revolution delivered another benefit for small businesses when the USPS became the first postal authority to approve the introduction of a system of applying to an envelope in the printer bin of a PC sheet printer a digital frank or stamp delivered via the Internet. With this innovative alternative to an adhesive-backed postage stamp as the basis for an Electronic Stamp Distribution (ESD) service, business envelopes could be produced in-house, addressed and customized with advertising information on the face, and ready to be mailed.

Digital printing is printing using digital techniques developed for computer printers such as inkjet or laser printers. The process differs from lithography, flexography, gravure, and letterpress printing in several ways. First, every print can be different, because printing plates are not required, as in traditional methods. Second, there is less waste chemical and paper, because there is no need to bring the image “up to color” and check for registration and position.

Digital Printing is used for personalized printing or variable data printing (VDP or Variable Imaging (VI)), for example personalized children's books, which are customized with the specific child's name and images. Print on Demand (POD) systems also use digital printing, for short run books of varying page quantities, and binding techniques. Digital prints can also be done on photographic paper, exposed with RGB laser lights from computer files, and processed in photographic developers and fixers. These prints are continuous tone images, and have the dyes imbedded in emulsion layers within plastic coatings. They can be archival.

### SUMMARY

The invention relates to systems for creating commingled mail that can be delivered through a postal system to multiple clients. The system can include a printing press, an inserting machine, a bar code reader, and software customized to control the aforementioned machines so that they operate in conjunction with one another to produce commingled direct mail intended for delivery to multiple clients.

This invention takes advantage of envelope manufacturing, printing and inserting, postal pre-sorting and mail commingling, and digital printing and creates a mail stream of envelopes that when finished are fine sorted to the postal carrier route level, personalized inside and outside by digital printing, and allows for the commingling of customers on a demand basis. Digital printing can also be used for personalizing mail pieces, and depending on the capability of the mailing company, personalized pieces can be created at any stage of the method, all the while maintaining the postal mail sort order.

The machinery necessary to make this invention can be purchased from several manufacturers; however, the various pieces of equipment have not been used together in this fashion and configuration nor has software ever previously been created to make the machines work in consort to achieve the desired results of a multi-client, fine sorted, national commingled direct mail stream.

One advantage of the systems and methods of the invention is their ability to improve the throughput speed and to yield significant monetary savings by maximizing the available postal pre-sort discounts. Additionally, the systems and methods of the invention save production costs and reduce waste. One such way that production costs and waste can be reduced is through the use of standard #10 white envelopes in each job performed using the system and methods herein rather than ordering printed envelopes for each particular job.

Accordingly, the invention features systems for creating a commingled mailing that can include a control printing device for printing a plurality of insertable sheets of material, an inserting machine, a detection device, and an envelope printing device for printing a plurality of envelopes. The system also features software installed on one or more computers for controlling the control printing device, the inserting machine, the detection device, and the envelope printing device to create a commingled mailing. The commingled mailing features two or more mail pieces wherein at least two of the two or more mail pieces are categorized in the same classes under current postal regulations.

The invention also features a system that selects a specific envelope from a plurality of envelopes in one or more envelope feeders using software installed on a first computer that controls selectable actions as directed from at least one database that is interpreted to select the specific envelope based upon personalized content printed on one or more sheets of material using a control printing device. Once the one or more sheets of material are printed with personalized content and non-personalized content, the one or more sheets of material are insertable into the selected specific envelope by an inserting machine. The system maintains a mail sort order for the plurality of envelopes.

In another aspect, the invention can also feature a detection device and the software can be an interpretation software application for identifying the specific envelope feeder from which an envelope of the plurality of envelopes is selected for insertion thereinto of the one or more sheets of material.

In another aspect, the invention can also feature the detection device and interpretation software application selecting printed content for envelope insertion.

In another aspect, the invention can also feature the software directing an envelope printing device to print personalized data on the selected specific envelope after the printed sheets of material are inserted therein.

In another aspect, the invention can also feature the personalized data being printed onto the envelope including at least one of the following: a recipient name, a recipient address, and a personalized message to a recipient.

The invention can also feature a system for creating commingled mail. The system can include a control printing device, one or more databases stored on a computing device, an inserting machine, and an envelope printing device. The control printing device can print onto a sheet of material (i) personalized information comprising a plurality of personalized data entries each of which is specific to an individual or household, (ii) customized information that is targeted toward a specific individual or household or a toward a predetermined group of individuals or households, and (iii) non-personalized information including one or more non-targeted items. The personalized information, customized advertising information, and non-personalized information are stored in the one or more databases, and the personalized information can be pre-sorted in mail-sorted order. The inserting machine inserts each sheet of material printed upon by the control printing device into an envelope selected from a plurality of envelopes, and the envelopes are maintained in the mail-sorted order assigned to the sheets of material inserted within them. The envelope printing device prints onto each of a plurality of envelopes personalized information that can include a plurality of personalized data entries each of which is specific to an individual or household. The system further includes software for controlling the control printing device and the envelope printing device to print each sheet of material grouped in order by individual, household, or group of individuals or households.

In another aspect, the invention can also feature the envelope printing device printing onto one or more of the plurality of envelopes at least one of (i) customized advertising information that can include a plurality of advertisements each of which is targeted toward a specific individual or household or a toward a predetermined group of individuals or households, and (ii) non-personalized information that can include one or more non-targeted items.

In another aspect, the invention can also feature the customized information printed onto the sheet of material and onto the envelope being at least one advertisement.

In another aspect, the invention can also feature the group of individuals or households including a mailing location selected from among the following: a street, a housing development, an apartment complex, a condominium complex, a neighborhood, a ZIP code, a city, a county, a geographical region, a state, and a country.

In another aspect, the invention can also feature the personalized information further including a plurality of unique identifiers, wherein each unique identifier is electronically associated with a single specific personalized data entry of the plurality of personalized data entries.

In another aspect, the invention can also feature the personalized information further including a plurality of unique identifiers, wherein each unique identifier is electronically associated with a single specific advertisement of the plurality of advertisements.

In another aspect, the invention can also feature a detection device for detecting a plurality of unique identifiers, one of which is printed on each sheet of material, and interpretation software for interpreting each unique identifier detected by the detection device, wherein each of the plurality of unique identifiers is uniquely associated with a single specific personalized data entry, a single specific advertisement, or a mailing location.

In another aspect, the invention can also feature the system further including sorting software that controls the inserting machine according to instructions received from the interpretation software based upon the interpretation software's recognition of each unique identifier.

In another aspect, the invention can also feature the sorting software being programmed to direct the inserting machine to choose from the one or more envelope feeders an envelope into which each sheet of printed material is inserted based upon instructions recorded in the one or more databases stored on the computing device.

In another aspect, the invention can also feature the system creating a plurality of commingled mail pieces in mail-sorted order according to the mail-sorted order specified in the database containing the personalized information.

A method of the invention can be used to commingle and control mail including the steps of: (a) compiling personalized information featuring a plurality of personal data entries in a mail-sorted database and non-personalized information in an unsorted database, wherein the databases are stored on a server; (b) using a control printing device, printing personalized information associated with a first personal data entry of the plurality of personal data entries and non-personalized information selected from the unsorted database on a plurality of sheets of material featuring a plurality of groups, each group featuring at least a first sheet, wherein the plurality of groups are manufactured in mail sort order, wherein the personalized information printed on each sheet of material features a unique identifier, and wherein the first personal data entry and associated personalized information is selected from the mail-sorted database by sorting software; (c) detecting and interpreting the unique identifier using a detection device and interpretation software; (d) using the interpretation software, selecting a specific group of sheets of material from the plurality of sheets of material based upon the interpretation of the unique identifier by the detection device; (e) inserting the specific group of sheets of material selected by the interpretation software into an envelope selected from a plurality of envelopes; (f) using the sorting software, printing personalized information associated with the first personal data entry onto the envelope, wherein the personalized information is selected from the mail-sorted database; and (g) maintaining the mail sort order of the plurality of groups inserted into the plurality of envelopes while repeating steps (a) through (f) of the method for a plurality of additional personal data entries selected by the sorting software from the personalized information stored in the mail-sorted database.

Another method of the invention can include the step of (h) delivering the plurality of envelopes containing the plurality of groups in mail-sorted order to a postal service for distribution to a plurality of customers.

Another method of the invention can include each unique identifier relating to at least one of the following: an individual customer among a plurality of customers, an individual retailer among a plurality of retailers, and an individual advertiser among a plurality of advertisers.

Another method of the invention can include each personal data entry in the mail-sorted database featuring a mailing address.

Another method of the invention can include each personal data entry in the mail-sorted database further featuring a customer name associated with the mailing address.

Another method of the invention can include the non-personalized information featuring advertising information of at least one advertiser.

Another method of the invention can include the advertising information featuring a plurality of advertisements.

Another method of the invention can include each of the plurality of advertisements being printed by the control printing device onto each group according to instructions provided by the sorting software.

Another method of the invention can include the sorting software and the interpretation software being installed on the server.

Another method of the invention can include the sorting software and the interpretation software being installed on one or more computers.

Unless otherwise defined, all technical terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents and other references mentioned herein are incorporated by reference in their entirety. In the case of conflict, the present specification, including definitions will control.

### BRIEF DESCRIPTION OF THE DRAWINGS

FIG. 1 is a schematic diagram of a system of the invention.

FIG. 2A is a flow chart showing processes and methods of the invention.

FIG. 2B is a continuation of the flow chart of FIG. 2A.

FIG. 2C is a continuation of the flow chart of FIG. 2B.

### DETAILED DESCRIPTION

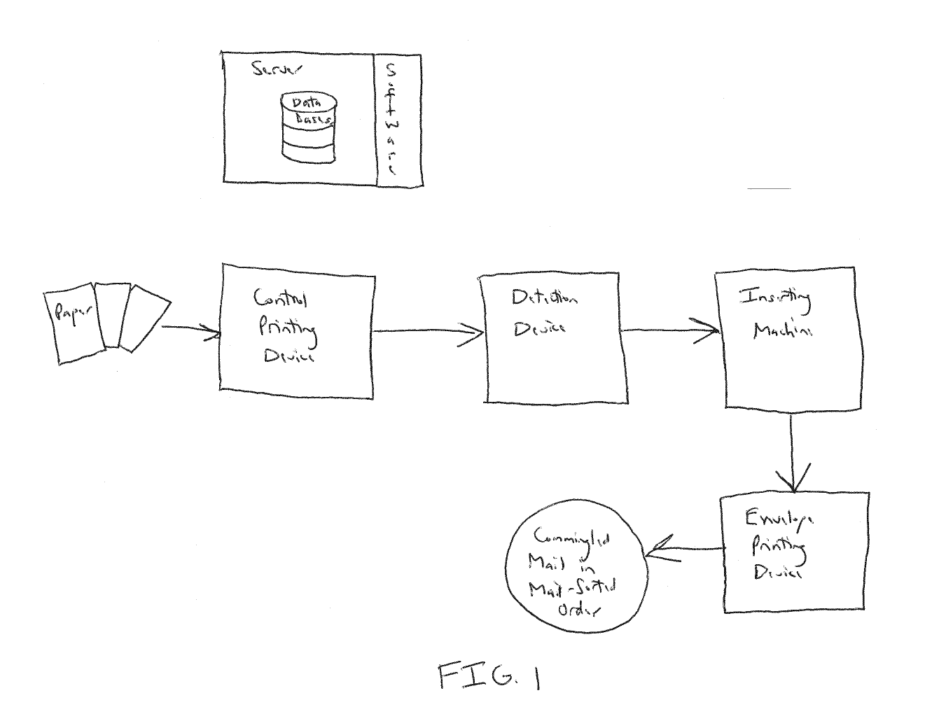

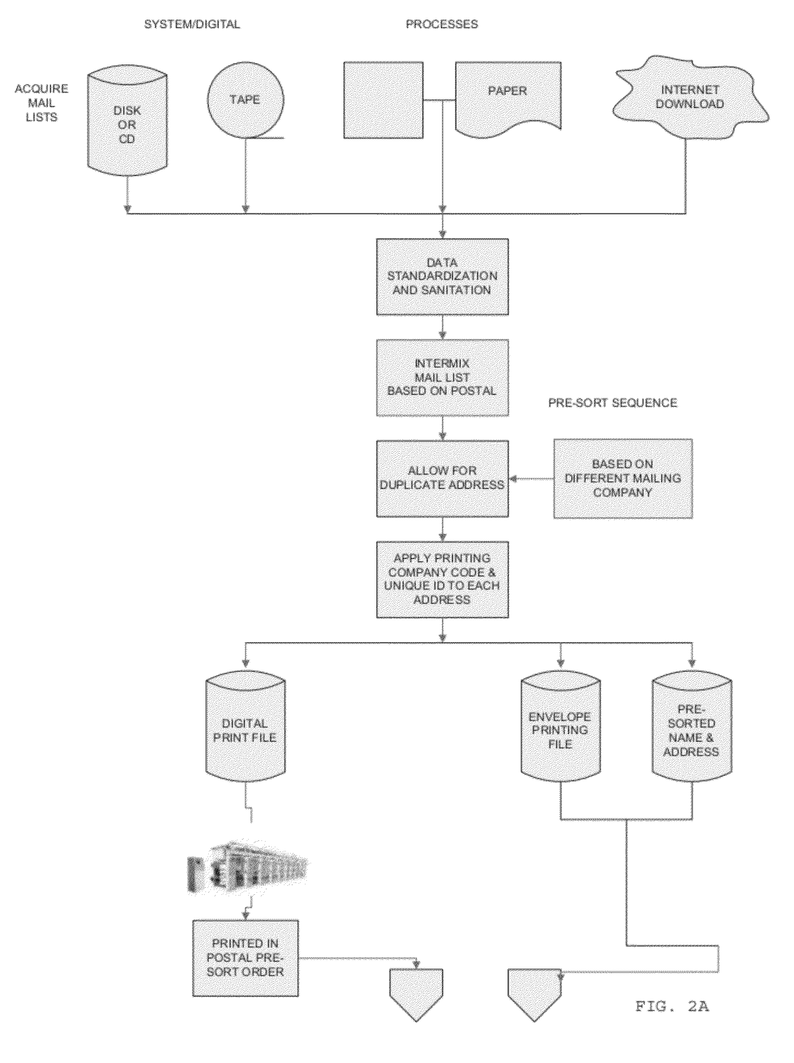

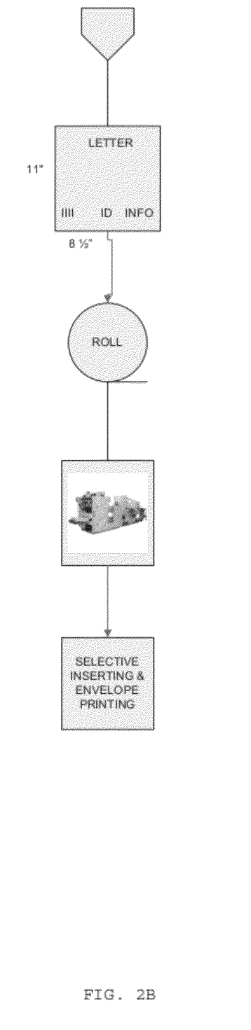

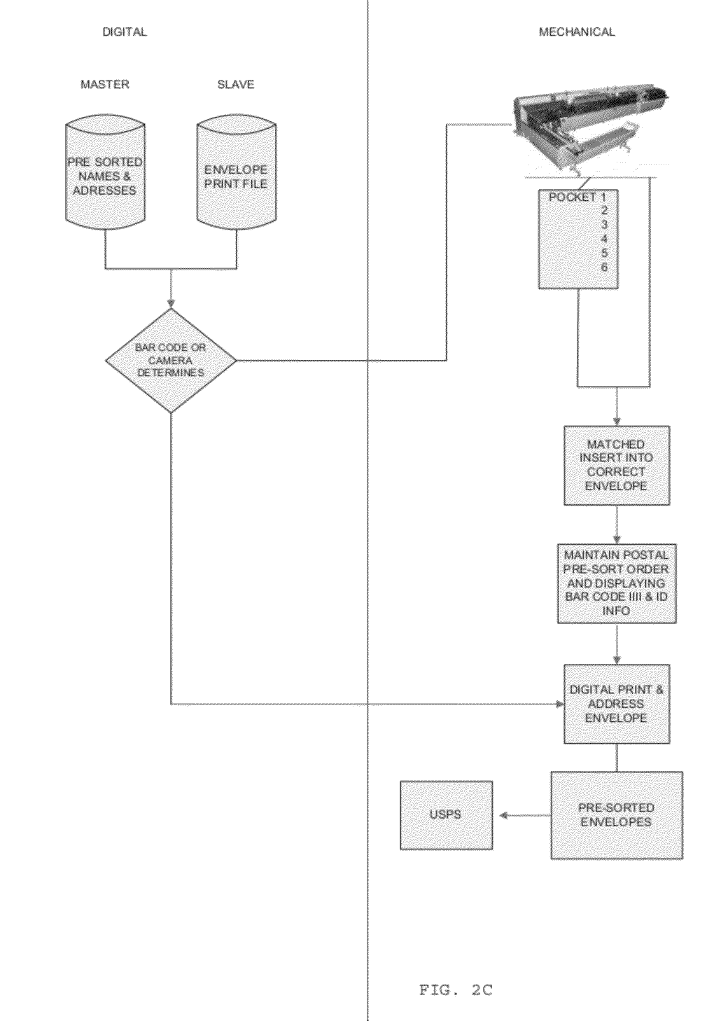

The invention provides a system for printing, packaging, and delivering commingled mail to multiple clients through a postal system. In an exemplary embodiment, similar to the one shown in FIGS. 1 and 2A-2C, a system of the invention can include a control printing device, an inserting machine, a detection device, an envelope printing device, and software customized to control the aforementioned machines so that they operate in conjunction with one another to produce commingled mail intended for delivery to multiple clients. The system also features software installed on one or more computers for controlling the control printing device, the inserting machine, the detection device, and the envelope printing device to create a commingled mailing. The commingled mailing features two or more mail pieces wherein at least two of the two or more mail pieces are categorized in the same classes under current postal regulations.

The control printing device of the system can be any printing device suitable for printing on a plurality of sheets of material. The control printing device can print onto a sheet of material (i) personalized information comprising a plurality of personalized data entries each of which is specific to an individual or household, (ii) customized advertising information comprising a plurality of advertisements each of which is targeted toward a specific individual or household or a toward a predetermined group of individuals or households, and (iii) non-personalized information comprising one or more non-targeted items. Non-targeted items can include text, graphics, or other content that is not personalized so as to be specific to a single individual, group of individuals, address, or group of addresses, but which is included in all of the mail pieces in a production batch. The personalized information, customized advertising information, and non-personalized information are stored in the one or more databases, and the personalized information can be pre-sorted in mail-sorted order. In exemplary embodiments, the control printing device can be a digital printing press. The control printing device used with this invention can be any printing device capable of receiving and feeding the sheets of the printable sheet of material therethrough. For example, the control printing device can be a an inkjet printer, a laser printer, a wide format plotter, a copy machine, a litho printer, or any other suitable type of printer. The control printing device can be a standard printing press, a digital printing device or a variable printing device. The envelope printing device can be the same type of printing device as the control printing device or a different type of printing device.

For purposes of convenience and not by way of limitation, paper shall be referenced as the material from which the form is constructed; however, the sheet or sheets of the form can be manufactured from any material that can be fed through a printing device and which has a surface on which the printing device may print. Suitable materials can include paper, plastic, metallic or semi-metallic foil, paperboard, and any other substrates on which the user may desire to print. The material can be of any weight, thickness, or stiffness or rigidity as long as the material is sufficiently flexible to be moved mechanically through the printing device. The material can also be any size or shape that can be received by and mechanically fed through the printing device.

The system features software that can select a specific envelope from a plurality of envelopes in one or more envelope feeders. The software controls selectable actions as directed from at least one database that is interpreted to select an envelope from a specific envelope feeder of the system based upon personalized content (e.g., the unique identifier) printed on one or more sheets of material using a control printing device. Once the one or more sheets of material are printed with personalized content and non-personalized content, the one or more sheets of material are insertable into the selected specific envelope by an inserting machine. The system maintains a mail sort order for the plurality of envelopes after the printed sheets of material have been inserted into their appropriate envelopes.

The detection device of the system can be a device capable of recognizing and extracting, interpreting, or reading data encoded in a unique identifier printed on one or more mail pieces, envelopes, or other packaging materials. In one embodiment, the detection device can be a bar code reader. The bar code reader can be a camera connected to a computer on which bar code reading software is installed. In another embodiment, the bar code reader can be a bar code scanner. In still another embodiment, the detection device can be an optical device for reading alphanumeric text. In yet another embodiment, the detection device can be a device for detecting code related to personalized content that is embedded in magnetic ink or strips. An interpretation software application can be used in conjunction with the detection device to identify the specific envelope feeder from which an envelope of the plurality of envelopes is selected for insertion thereinto of the one or more sheets of material.

In an exemplary embodiment, the detection device and interpretation software application selects printed content for envelope insertion.

The inserting machine inserts each sheet of material printed upon by the control printing device into an envelope selected from a plurality of envelopes, and the envelopes are maintained in the mail-sorted order assigned to the sheets of material inserted within them.

The envelope printing device prints onto each of a plurality of envelopes personalized information that can include a plurality of personalized data entries each of which is specific to an individual or household. The system further includes software for controlling the envelope printing device to print each envelope grouped in order by individual, household, or group of individuals or households. The envelope printing device can print onto one or more of the plurality of envelopes at least one of (i) customized advertising information that can include a plurality of advertisements each of which is targeted toward a specific individual or household or a toward a predetermined group of individuals or households, and (ii) non-personalized information that can include one or more non-targeted items. The group of individuals or households can include a mailing location selected from among the following: a street, a housing development, an apartment complex, a condominium complex, a neighborhood, a ZIP code, a city, a county, a geographical region, a state, and a country.

The software can direct the envelope printing device to print personalized data on the selected specific envelope after the printed sheets of material are inserted therein. The personalized data being printed onto the envelope can include at least one of the following: a recipient name, a recipient address, and a personalized message to a recipient.

The personalized information includes a plurality of unique identifiers. In one embodiment, each unique identifier can be electronically associated with a single specific personalized data entry of the plurality of personalized data entries. In another embodiment, each unique identifier can be electronically associated with a single specific advertisement of the plurality of advertisements. As discussed herein, the detection device can detect the plurality of unique identifiers, one of which is printed on each sheet of material, and the interpretation software can interpret each unique identifier detected by the detection device to determine which envelope feeder an envelope should be selected from for inserting the printed materials. Each of the plurality of unique identifiers is uniquely associated with a single specific personalized data entry, a single specific advertisement, or a mailing location.

In an exemplary embodiment, the system can also feature sorting software that controls the inserting machine according to instructions received from the interpretation software based upon the interpretation software's recognition of each unique identifier. The sorting software can be programmed to direct the inserting machine to choose from the one or more envelope feeders an envelope into which each sheet of printed material is inserted based upon instructions recorded in the one or more databases stored on the computing device.

The inserting machine can include multiple stacker devices for collating and inserting direct mail pieces of different types into a single envelope, package, or mailing.

In another embodiment, the system can also include an envelope press to construct envelopes around the commingled direct mail pieces being mailed. The envelope press can include a die cutting machine.

In another embodiment, the system can also include a poly-bagging machine or a shrink-wrapping machine to wrap and package the commingled direct mail pieces being mailed together.

The various machines of the system can be connected together by conveyor belts or another mechanical conveying system that transports unfinished materials between machines of the system so that the unfinished materials can be constructed into finished commingled mail packages. In another embodiment, the unfinished pieces can be manually transported from one machine of the system to another.

The software can be installed on a single computer that controls the operation of all of the system's machines. In another embodiment, the software can be installed on computers that are part of each machine.

The system can create a plurality of commingled mail pieces in mail-sorted order according to the mail-sorted order specified in the database containing the personalized information.

The invention also provides methods for creating commingled mail that can be delivered through a postal system such as the United States Postal Service (USPS) to multiple clients. The methods of the invention can be used to commingle mail and to control the process so that the commingled mail is arranged in mail-sorted order. The multiple clients referred to herein are mail recipients.

In one step of the method, personalized information is compiled, which features a plurality of personal data entries in a mail-sorted database and non-personalized information in an unsorted database. The databases can be stored on a server. In another step of the method, a control printing device can be used to print personalized information associated with a first personal data entry of the plurality of personal data entries and non-personalized information selected from the unsorted database onto a plurality of sheets of material. The plurality of sheets of material are arranged into a plurality of groups with each group featuring at least a first sheet. The plurality of groups are manufactured in mail-sorted order. The personalized information printed onto each sheet of material can feature a unique identifier such as, for example, a bar code or an alphanumeric code. The first personal data entry and associated personalized information can be selected from the mail-sorted database by sorting software.

In another step of the method, the unique identifier can be detected and interpreted using a detection device and interpretation software; (d) using the interpretation software, selecting a specific group of sheets of material from the plurality of sheets of material based upon the interpretation of the unique identifier by the detection device; (e) inserting the specific group of sheets of material selected by the interpretation software into an envelope selected from a plurality of envelopes; (f) using the sorting software, printing personalized information associated with the first personal data entry onto the envelope, wherein the personalized information is selected from the mail-sorted database; and (g) maintaining the mail sort order of the plurality of groups inserted into the plurality of envelopes while repeating steps (a) through (f) of the method for a plurality of additional personal data entries selected by the sorting software from the personalized information stored in the mail-sorted database.

The method can also include the step of delivering the plurality of envelopes containing the plurality of groups in mail-sorted order to a postal service for distribution to a plurality of customers.

In the method, each unique identifier can relate to at least one of the following: an individual customer among a plurality of customers, an individual retailer among a plurality of retailers, and an individual advertiser among a plurality of advertisers. In one embodiment, each personal data entry in the mail-sorted database can feature a mailing address. In another embodiment, each personal data entry in the mail-sorted database can further feature a customer name associated with the mailing address.

The non-personalized information used in the method can include advertising information o f or from at least one advertiser. The advertising information can feature a plurality of advertisements, which can be related to the advertiser or the advertiser's customer's goods or services. The advertiser can be an advertising or marketing firm placing advertisements on behalf of others, a retailer, a distributor, or a manufacturer. Each of the plurality of advertisements can be printed by the control printing device onto each group according to instructions provided by the sorting software.

The sorting software and the interpretation software used in the method can be installed on the server or on another computing device communicatively connected to the system. For example, the sorting software and the interpretation software can be installed on one or more computers of the system.

In another embodiment of the method, in a first step, software installed on a computer can be used to manipulate data contained in a mailing list as required by the user. In one embodiment, the software can combine or commingle two or more mailing lists provided by at least two different customers. In another embodiment, the software can commingle multiple pieces of mail for delivery to the same customer. The data contained in each mailing list can include, for example, names, pre-fix and suffix standardization, and addresses including zip codes for the finest level of sorting and pre-sorting. The mailing list data pertaining to zip codes can include interpretation of the Intelligent Mail Bar (IMB) bar coding data for sorting the records, regardless of customer (i.e., list owner), into a single sequence. The process of interpreting the IMB bar coding data can also include performing necessary concentration analysis in order to create the most efficient pre-sort sequence down to the carrier route sequence level when possible.

The processes of address sanitization and standardization can be performed using the software. At the time the mailing lists are being compared, duplicates would not be eliminated by the software, but rather, all records can be coded and bar-coded for customer record ownership, envelope selection, envelope printing, and Variable Print Record (VPR) purposes, among other purposes. By deploying this technique the software can create identifiable, larger, more concentrated sorted mailing lists. Additionally, by commingling and concentrating the lists, the software of the method can be scalable so that it may be used efficiently on a national basis, which is heretofore unavailable. The software can function continuously and simultaneously with the digital printing and production processes described below.

In a second step of the method, VPR can be used to create one or more customized printed mail pieces. The printed customizations can include names and other variable text. The customized, four-color printed mail pieces can be managed with either roll-to-roll finishing, roll-to-sheet finishing, sheet-to-sheet finishing, or in-line finishing.

When finished, depending on whether roll-to-roll finishing or in-line finishing was used, a finished roll or collated bundle will be produced. Either the resulting roll or the collated bundle then can be processed so that the material can be placed into a stacker and placement device o fan inserting machine for insertion into envelopes.

In a third step of the method, a bar code reader, as described herein in relation to the system of the invention, can read the code or bar code created in the first step of the method. After reading the code, the coded data obtaining from the reading can be used to selectively choose an envelope, for example, a #10 envelope or a #10 envelope with window, from a stacker device o f an inserting machine in which the customized printed materials (i.e., the roll or collated bundle) have been placed. The inserting machine can insert the bundle, letter, or other printed mail piece into a selected envelope, and the envelope can be sealed. The envelopes can be tiled or layered on a conveyer in no particular order but maintaining the pre-sort sequence created in the first step. In this way, blind envelopes or window envelopes where the name address and postal bar code is readable through the window can be placed on the conveyer in random order.

In a fourth step of the method, a printing press, for example, a digital printing press, can print black only or four-color process or any combination of colors or spot colors for printing on the envelopes. Based on the code or bar code developed and printed in the first step, a digital printing press can be employed to print the finished envelopes. The exterior printing of the envelopes can be controlled by the code or bar code; however, the envelope exterior printing can be performed according to the postal pre-sort order rather than traditional envelope printing that is completed before the envelopes have the customized mail pieces inserted, which offers no selectivity. In exemplary embodiments, digital printing is used for its ability to print names, addresses, postal bar codes, and additional data or personalization to the envelope that matches the mail pieces inserted inside.

In a fifth step of the method, the completed (stuffed and personalized) and printed envelopes can be bundled and packaged for USPS certification (or delivery to another postal or courier service), trucking and delivery to regional postal facilities, and eventually entered into the mail stream while maintaining the pre-sort order and delivered to the home, individual or business. The custom printed mail pieces inserted into custom printed envelopes, which are bundled, marked and commingled, can be loaded into a labeled mail tray certified and ready for delivery and entry into the USPS system.

The steps of the method are described above in a particular order; however, with the exception of the first and fifth steps, the other steps may be completed in a different order than that described herein.

### Other Embodiments

It is to be understood that while the invention has been described in conjunction with the detailed description thereof the foregoing description is intended to illustrate and not limit the scope of the invention, which is defined by the scope of the appended claims. Other aspects, advantages, and modifications are within the scope of the following claims.

What is claimed is:

1. A system for creating a commingled mailing comprising:
a control printing device for printing a plurality of insertable sheets of material;
an inserting machine;
a detection device;
an envelope printing device for printing a plurality of envelopes; and
software installed on one or more computers for controlling the control printing device, the inserting machine, the detection device, and the envelope printing device to create a commingled mailing comprising two or more mail pieces wherein at least two of the two or more mail pieces are categorized in the same classes under current postal regulations.

2. A system that selects a specific envelope from a plurality of envelopes in one or more envelope feeders using software installed on a first computer that controls selectable actions as directed from at least one database that is interpreted to select the specific envelope based upon personalized content printed on one or more sheets of material using a control printing device, wherein, once the one or more sheets of material are printed with personalized content and non-personalized content, the one or more sheets of material are insertable into the selected specific envelope by an inserting machine, and wherein the system maintains a mail sort order for the plurality of envelopes.

3. The system of claim 2, wherein the system further comprises a detection device and the software comprises an interpretation software application for identifying the specific envelope feeder from which an envelope of the plurality of envelopes is selected for insertion thereinto of the one or more sheets of material.

4. The system of claim 3, wherein the detection device and interpretation software application select printed content for envelope insertion.

5. The system of claim 2, wherein the software directs an envelope printing device to print personalized data on the selected specific envelope after the printed sheets of material are inserted therein.

6. The system of claim 5, wherein the personalized data printed onto the envelope comprises at least one of the following: a recipient name, a recipient address, and a personalized message to a recipient.

7. A system for creating commingled mail, the system comprising:
a control printing device for printing onto a sheet of material (i) personalized information comprising a plurality of personalized data entries each of which is specific to an individual or household, (ii) customized information comprising that is targeted toward a specific individual or household or a toward a predetermined group of individuals or households, and (iii) non-personalized information comprising one or more non-targeted items;
one or more databases stored on a computing device, wherein the personalized information, customized advertising information, and non-personalized information are stored in the one or more databases, wherein the personalized information is pre-sorted in mail-sorted order;
an inserting machine for inserting each sheet of material printed upon by the control printing device into an envelope selected from a plurality of envelopes, wherein the envelopes are maintained in the mail-sorted order assigned to the sheets of material inserted within them;
an envelope printing device for printing onto each of a plurality of envelopes personalized information comprising a plurality of personalized data entries each of which is specific to an individual or household; and
software for controlling the control printing device and the envelope printing device to print each sheet of material grouped in order by individual, household, or group of individuals or households.

8. The system of claim 7, wherein the envelope printing device prints onto one or more of the plurality of envelopes at least one of (i) customized information that is targeted toward a specific individual or household or a toward a predetermined group of individuals or households, and (ii) non-personalized information comprising one or more non-targeted items.

9. The system of claim 8, wherein the customized information printed onto the sheet of material and onto the envelope comprises at least one advertisement.

10. The system of claim 7, wherein the group of individuals or households comprises a mailing location selected from the group consisting of: a street, a housing development, an apartment complex, a condominium complex, a neighborhood, a ZIP code, a city, a county, a geographical region, a state, and a country.

11. The system of claim 7, wherein the personalized information further comprises a plurality of unique identifiers, wherein each unique identifier is electronically associated with a single specific personalized data entry of the plurality of personalized data entries.

12. The system of claim 7, wherein the personalized information further comprises a plurality of unique identifiers, wherein each unique identifier is electronically associated with a single specific advertisement of the plurality of advertisements.

13. The system of claim 7, further comprising a detection device for detecting a plurality of unique identifiers, one of which is printed on each sheet of material, and interpretation software for interpreting each unique identifier detected by the detection device, wherein each of the plurality of unique identifiers is uniquely associated with a single specific personalized data entry, a single specific advertisement, or a mailing location.

14. The system of claim 13, wherein the system further comprises sorting software that controls the inserting machine according to instructions received from the interpretation software based upon the interpretation software's recognition of each unique identifier.

15. The system of claim 14, wherein the sorting software is programmed to direct the inserting machine to choose from the one or more envelope feeders an envelope into which each sheet of printed material is inserted based upon instructions recorded in the one or more databases stored on the computing device.

16. The system of claim 15, wherein the system creates a plurality of commingled mail pieces in mail-sorted order according to the mail-sorted order specified in the database containing the personalized information.

17. A method for commingling and controlling mail comprising the steps of:
(a) compiling personalized information comprising a plurality of personal data entries in a mail-sorted database and non-personalized information in an unsorted database, wherein the databases are stored on a server;
(b) using a control printing device, printing personalized information associated with a first personal data entry of the plurality of personal data entries and non-personalized information selected from the unsorted database on a plurality of sheets of material comprising a plurality of groups, each group comprising at least a first sheet, wherein the plurality of groups are manufactured in mail sort order, wherein the personalized information printed on each sheet of material comprises a unique identifier, and wherein the first personal data entry and associated personalized information is selected from the mail-sorted database by sorting software;
(c) detecting and interpreting the unique identifier using a detection device and interpretation software;
(d) using the interpretation software, selecting a specific group of sheets of material from the plurality of sheets of material based upon the interpretation of the unique identifier by the detection device;
(e) inserting the specific group of sheets of material selected by the interpretation software into an envelope selected from a plurality of envelopes;
(f) using the sorting software, printing personalized information associated with the first personal data entry onto the envelope, wherein the personalized information is selected from the mail-sorted database; and
(g) maintaining the mail sort order of the plurality of groups inserted into the plurality of envelopes while repeating steps (a) through (f) of the method for a plurality of additional personal data entries selected by the sorting software from the personalized information stored in the mail-sorted database.

18. The method o f claim 17, wherein the method further comprises the step of:
(h) delivering the plurality of envelopes containing the plurality of groups in mail-sorted order to a postal service for distribution to a plurality of customers.

19. The method of claim 17, wherein each unique identifier relates to at least one of the following: an individual customer among a plurality of customers, an individual retailer among a plurality of retailers, and an individual advertiser among a plurality of advertisers.

20. The method of claim 17, wherein each personal data entry in the mail-sorted database comprises a mailing address.

21. The method of claim 20, wherein each personal data entry in the mail-sorted database further comprises a customer name associated with the mailing address.

22. The method of claim 17, wherein the non-personalized information comprises advertising information of at least one advertiser.

23. The method of claim 22, wherein the advertising information comprises a plurality of advertisements.

24. The method of claim 23, wherein each of the plurality of advertisements is printed by the control printing device onto each group according to instructions provided by the sorting software.

25. The method of claim 17, wherein the sorting software and the interpretation software are installed on the server.

26. The method of claim 17, wherein the sorting software and the interpretation software are installed on one or more computers.
